(19) United States
(12) Patent Application Publication
(10) Pub. No.: US 2008/0216392 A1
(43) Pub. Date: Sep. 11, 2008

(54) PROCESSING PAINT SLUDGE TO PRODUCE A COMBUSTIBLE FUEL PRODUCT

(76) Inventors: Joe P. McCarty, Clarkston, MI (US); Daniel M. St. Louis, Wichita, KS (US)

Correspondence Address: BUTZEL LONG;IP DOCKETING DEPT, 350 SOUTH MAIN STREET, SUITE 300, ANN ARBOR, MI, 48104, US

(21) Appl. No.: 11/681,933

(22) Filed: Mar. 5, 2007

(51) Int. Cl. C10L 1/10; C02F 1/52

(52) U.S. Cl. 44/311; 210/712; 210/713

(57) ABSTRACT

A method for producing a combustion product that involves dewatering raw paint sludge from spray paint booth operations and adding a de-sulfuring agent thereto. The resulting material can provide significant and economical fuel value and sulfur emissions control to combustion processes such as for power plants while also obviating the need to dispose of waste paint sludge in landfills. Additionally the process is inexpensive, safe and free of most problems associated with paint sludge drying.

### TECHNICAL FIELD

The present invention relates generally to processing paint sludge. In particular, the present invention is directed to a method of producing a combustible fuel product from paint sludge which involves drying raw paint sludge from paint booth operations into a product that provides significant fuel value and de-sulfuring benefits for combustion processes such as fuels used in power and heat generating plants and facilities.

### BACKGROUND ART

Paint sludge poses a serious and expensive waste disposal problem for painting operations in manufacturing plants. When an object such as an automobile assembly or component is painted in a paint spray booth, the excess paint or overspray is typically collected in a water curtain and/or in a water stream underneath floor grating beneath the paint booth. This collected material is known as paint sludge. Disposing of paint sludge waste poses a problem of considerable complexity to paint booth operators. Current disposal technology is based upon incineration, or chemical and/or physical treatment together with solidification for purposes of landfill disposal. However, the disposal of paint sludge in landfills raises environmental concerns due to the fact that paint sludge typically contains numerous hazardous components. Such environmental concerns create the potential for long term liabilities and incur costs for special precautions that are needed to handle such waste materials.

Attempts have been made to create useful byproducts from paint sludge in order to gain or recover some value and lower the overall costs of processing the paint waste. Most of these attempts involved complex, potentially dangerous and problematic processing steps which add to the overall processing costs. Such high costs severely limit commercial interest in processing paint sludge.

U.S. Pat. No. 5,004,550 to Beckman et al. discloses a method for disposing of paint sludge that involves the addition of detackification agents to paint sludge in order to float the resulting product out of a paint sludge pit.

U.S. Pat. No. 5,160,628 to Gerace et al. discloses a method for making a filler from automotive paint sludge which involves a two-step process for handling paint sludge. In a first step Gerace et al. requires the mechanical removable of water from paint sludge. In the second step Gerace et al. uses chemical drying agents to remove further water and to produce a dried paint sludge powder containing uncured polymer.

U.S. Pat. No. 5,259,977 to Girovich et al. discloses a method and apparatus for the treatment of sewage sludge. Girovich et al teaches the desirability of an agglomerization or pelletization step in the treatment of organic sludge and discloses the use of quicklime in the treatment of organic sludge for the purposes of diminishing odors and neutralizing pathogens.

U.S. Pat. No. 5,489,333 to Soroushian et al. discloses the use of dried paint sludge powder as a filler admixed in Portland cement.

U.S. Pat. No. 5,573,587 to St. Louis discloses a method of paint sludge conversion that is used to produce building materials. St. Louis teaches pretreating paint sludge with sodium hydroxide before chemically drying the sludge.

U.S. Pat. No. 5,573,587 to St. Louis discloses mixing raw paint sludge with quicklime (CaO) to chemically dry the sludge and thereafter creating a powder of paint solids and slaked lime which is used as a component for use in mortar, cement, concrete and asphalt.

U.S. Pat. No. 6,673,322 to Santilli discloses a device for converting waste material into a fuel using a complex and potentially dangerous electric arc process to convert the molecular structure of these wastes into fuel.

Other patents that disclose various manners of processing paint sludge include U.S. Pat. Nos. 4,303,559 to Trost, 4,423,688 to Kuo, 4,426,936 to Kuo, 4,436,037 to Kuo and 6,119,607 to Guy et al.

Processing of paint sludge is time consuming and costly. Accordingly, there is need for a simple process that effectively collects and uses all of the paint sludge solids generated by paint booth facilities.

Landfill disposal of paint sludge is an environmentally undesirable method of disposing of waste paint sludge. Accordingly, there is a need for a better alternative method for disposal or recycling of waste paint sludge.

The present invention provides a simple and economic process for collecting, processing and using all of the paint sludge solids generated by paint booth facilities. Moreover, the present invention provides a method of producing a combustible fuel product from paint sludge which can be used to supplement fuel supplies used in power and heat generating plants and similar facilities and applications.

There are environmental concerns associated with fossil fuel consuming combustion processes such as power and heat generating plants and similar facilities and applications in terms of sulfur emissions such as SO and SO₂.

In addition to producing a combustible fuel product from paint sludge which can be used to supplement fuel supplies used in power and heat generating plants and similar facilities and applications, the present invention provides a fuel product from paint sludge which has de-sulfuring benefits for combustion processes such as fuels used in power and heat generating plants and facilities.

### DISCLOSURE OF THE INVENTION

According to various features, characteristics and embodiments of the present invention which will become apparent as the description thereof proceeds, the present invention provides a process of producing a combustible fuel from paint sludge which involves the steps of:

a) obtaining raw paint sludge from a painting facility;

b) subjecting the raw paint sludge to a dewatering process to obtain a dewatered paint sludge;

c) adding calcium oxide to the dewatered paint sludge to obtain a combustion fuel component; and

d) mixing the combustion fuel component from step c) with carbonaceous material to produce a combustible fuel.

The present invention further provides a combustible fuel produced by:

a) obtaining raw paint sludge from a painting facility;

b) subjecting the raw paint sludge to a dewatering process to obtain a dewatered paint sludge;

c) adding calcium oxide to the dewatered paint sludge to obtain a combustion fuel component; and

d) mixing the combustion fuel component from step c) with carbonaceous material to produce a combustible fuel.

The present invention further provides method of processing paint sludge which involves:

a) obtaining raw paint sludge from a painting facility;

b) subjecting the raw paint sludge to a dewatering process to obtain a dewatered paint sludge;

c) adding calcium oxide to the dewatered paint sludge to obtain a combustion fuel component; and

d) mixing the combustion fuel component from step c) with carbonaceous material to produce a combustible fuel; and

d) combusting the combustible fuel.

### BRIEF DESCRIPTION OF DRAWINGS

The present invention will be described with reference to the attached drawings which are given as non-limiting examples only, in which:

FIG. 1 is a process flow diagram of a process for drying paint sludge according to one embodiment of the present invention.

FIG. 2 is a process flow diagram of a process for drying paint sludge according to another embodiment of the present invention which includes thermal treatment.

FIG. 3 is a process flow diagram of a process for drying paint sludge according to another embodiment of the present invention which includes thermal treatment and separation of constituents.

FIGS. 4-6 are graphs which plot the change of temperature of mixtures of paint sludges having different solids content and different amounts of calcium oxide (lime).

FIGS. 7-10 are graphs which plot percentage of solids in the paint sludge/calcium oxide mixtures over time for different amounts paint sludge/calcium oxide (lime).

### BEST MODE FOR CARRYING OUT THE INVENTION

The present invention is directed to a method of producing a combustible fuel product from paint sludge which involves drying raw paint sludge from paint booth operations into a product that provides significant fuel value and de-sulfuring benefits for combustion processes such as fuels used in power and heat generating plants and facilities.

According to the present invention raw paint sludge from a painting operation is collected by separating the paint overspray particles from the spray booth water. The raw paint sludge is then subjected to a dewatering step in which a first portion of the water is removed to provide a concentrated sludge of up to about 65% solids. The dewatering step can involve mechanically draining water from the raw paint sludge or any process that removes excess water from the paint sludge. Examples of suitable dewatering processes include filtration, filter pressing, centrifugation, decantation, distillation, extraction, freeze drying, fluidized bed drying and similar processes that can be used to mechanically remove excess water from the raw paint sludge. Removal of excess water by decantation according to the present invention offers a cost efficient manner of dewatering the raw paint sludge.

According to one embodiment of the present invention dewatered sludge is treated by adding calcium oxide (lime) thereto.

The present invention will be discussed hereafter with reference to the figures in which common reference numerals are used to identify similar equipment/elements throughout the drawings.

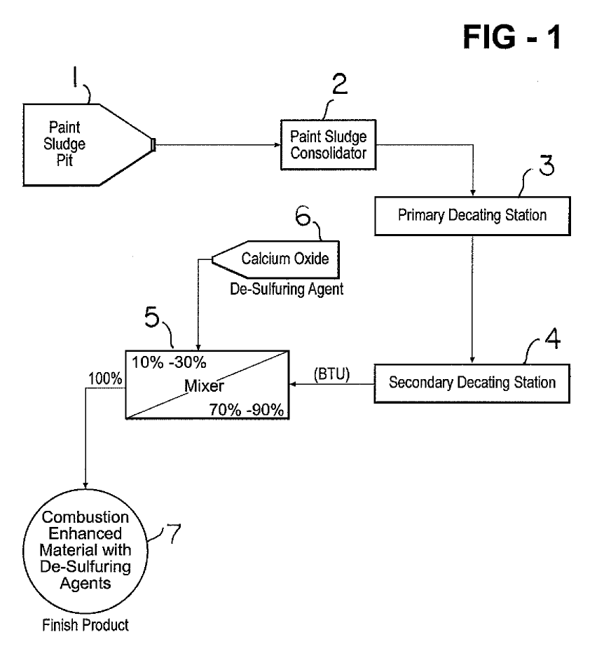

FIG. 1 is a process flow diagram of a process for drying paint sludge according to one embodiment of the present invention. As shown in FIG. 1 paint sludge which can be collected from a typical paint sludge pit 1 and consolidated in any conventional manner at 2 for, by example by a paint sludge skimmer, is subjected to a one or more dewatering steps 3 and 4 as discussed above. The dewatered paint sludge which has a solids content of up to 65 weight percent is fed into mixer 5 (blender, pug mill or any equipment that will make a consistent homogeneous blend) together with calcium oxide 6 and the mixture is formed into a consistent homogeneous blend while the calcium oxide reacts with the dewatered paint sludge.

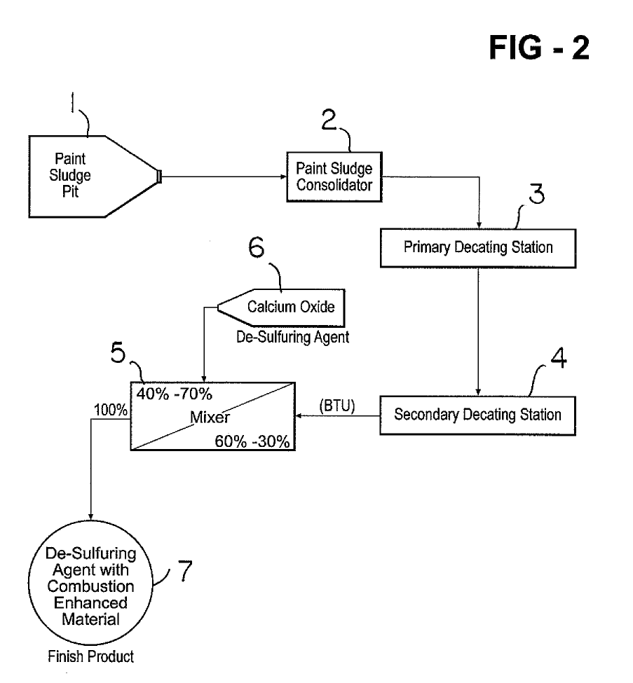

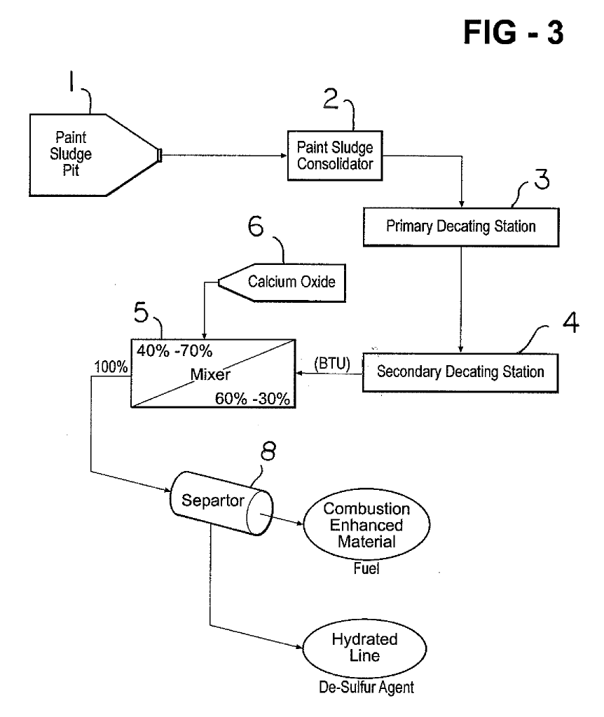

The amount or weight of the calcium oxide added, combined and reacted with the paint sludge effects the de-sulfuring benefit and caloric Btu value of the resulting fuel component. Accordingly, a weight scale or load cell can be used in the process shown in FIG. 1. (And FIGS. 2 and 3).

Weight measurement of each of the dewatered paint sludge and calcium oxide is important for the following reasons:

First, combining the right amount of calcium oxide and paint sludge is important in order to achieve a material that is flowable, pumpable and easy to handle. Paint solids coming from a spray booth water system is typically chemically treated with detackifying chemical that helps to create the paint sludge particles. When the paint sludge is dewatered or dried through any means that releases water, for example by pressure, vibration, centrifuging, or drying, the paint sludge will loose a good portion of its detackifying properties and will become sticky (live) again.

When calcium oxide is mixed with the paint solids it has the effect of eliminating the possibility of bridging, building-up, or coating, mechanical equipment used to process the paint sludge. The calcium oxide creates a chemical bond with the paint solids which removes the stickiness from the paint solids. The combined material from mixer 5 can thus be physically or mechanically moved throughout the process equipment by conveying or pumping the mixture or chemically treated sludge with minimal effect on the equipment.

Combining the right amount of calcium oxide and paint sludge is also important to achieve the night product balance for the end user. When calcium oxide is mixed with water it forms calcium hydroxide (slaked lime). The reaction is exothermic and generates heat. The more calcium oxide used, the more heat will be generated.

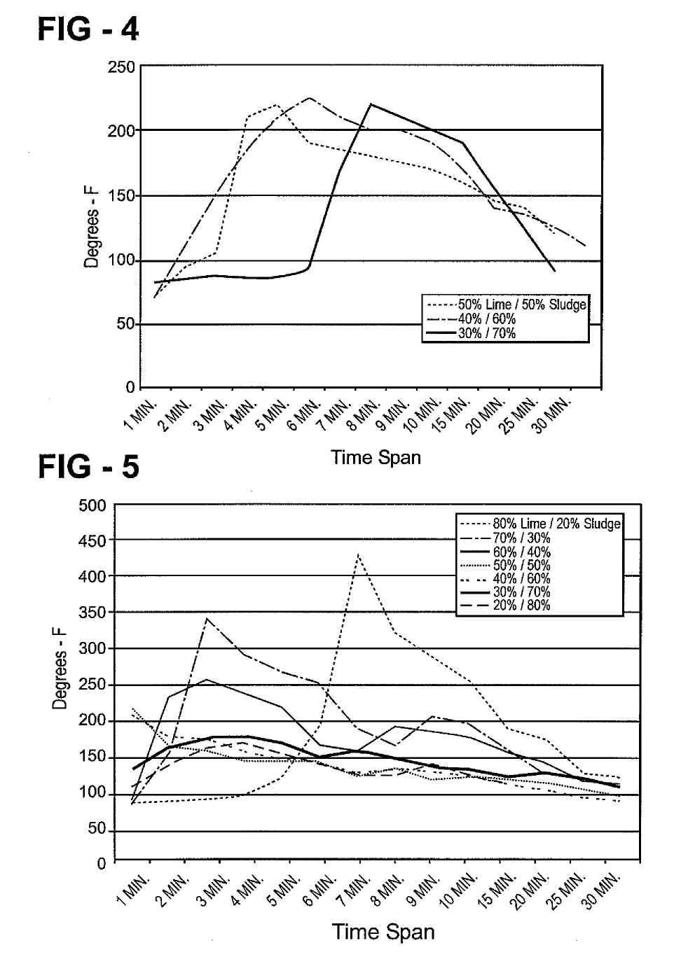

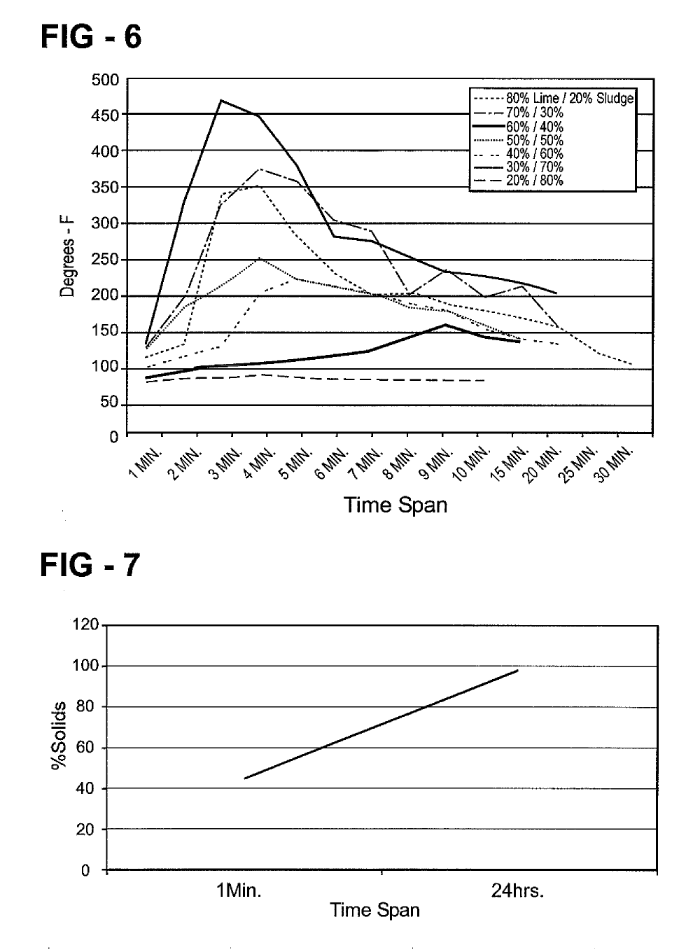

FIGS. 4-6 are graphs which plot the change of temperature of mixtures of paint sludges having different solids content and different amounts of calcium oxide (lime). The temperatures of the mixtures are plotted over time so that the change in temperature can be observed.

As can be seen from FIGS. 4-6, it is possible to control the amount of heat that is generated by adjusting the amount of calcium oxide and paint sludge. Controlling the temperature of the reaction is important because it effects whether a semi-cured or a completely cured product is produced.

The amount of calcium oxide added will also provide the end user, i.e. one who uses the fuel product in combustion processes such as for fuels used in power and heat generating plants and facilities with desired de-sulfuring benefits (in addition to significant fuel values).

In this regard, by adding calcium oxide to the paint solids at different weight percentages it is possible to produce a fuel product having different percentages of lime available for pollution control in combustion processes such power and heat generating plants and facilities. The calcium oxide (lime) is used in stack gas scrubbers to reduce sulfur dioxide emissions from combustion processes such power and heat generating plants and facilities. The sulfur dioxide reacts with the lime to form solid calcium sulfite. When the fuel product of the present invention is combined with a carbonaceous material such as coal, it is possible according to the present invention to adjust the amount of calcium oxide added to compensate for the characteristics of the carbonaceous material, it being known for example that coal from different sources produces different amounts of sulfur dioxide emissions.

Paint sludges having different solid percentages by weight will also require varying addition of calcium oxide added thereto in order to compensate for amount of water in the paint sludges as indicated in FIGS. 4-6.

In addition to generating heat and effecting curing of the paint product, and providing a de-sulfuring property, the amount of calcium oxide introduced into the paint sludge effects a change in the composition of the water which generates significantly higher percent solids of the combined product.

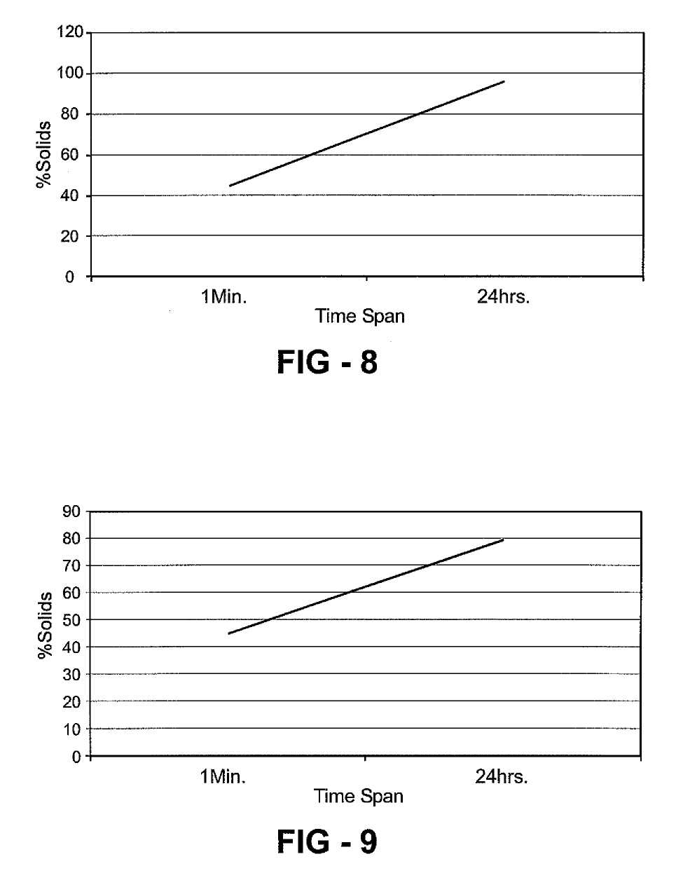

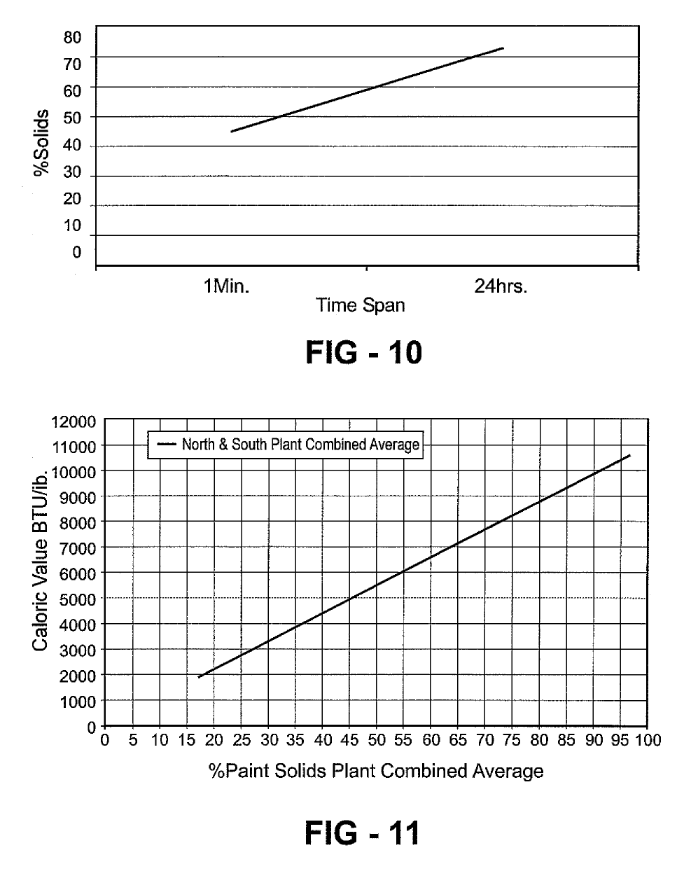

FIGS. 7-10 are graphs which plot percentage of solids in the paint sludge/calcium oxide mixtures over time for different amounts paint sludge/calcium oxide (lime). The percentages of solids of the mixtures are plotted over time so that the change in solids percentage can be observed.

As can be observed from FIGS. 7-10, when calcium oxide is added to a dewatered paint sludge, the solids percentage increases over time. As a result, as less water remains in the mixture, the caloric Btu value of the paint solids increase.

Further, the heat generated by the exothermic reaction between the paint sludge and the calcium oxide can be used to remove water from the mixture by conducting evaporative heating in the mixer 5 by providing conventional means to remove vapor from the mixer 5 after the calcium oxide and paint sludge have been blended and begin to react.

FIG. 11 is a graph which plots the caloric value (Btu/lb) against the solids percentage by weight of paint sludge. As can be seen in FIG. 11, as the solids percentage increases in a paint sludge, the caloric value also increases.

Thus, when calcium oxide is added to paint sludge and causes an increase in the solids percentage, there is a corresponding increase in the caloric value.

Therefore the process of the present invention process provides a fuel component that can be combined with a carbonaceous fuel to produce a fuel product that provides two benefits when combusted in power and heat generating plants and similar facilities, including a de-sulfuring agent and recovered fuel.

The amount of calcium oxide that is to be added to the paint sludge can also be used to determine the type of equipment that should be used to manufacture the de-sulfuring/caloric Btu product. For example, when more calcium oxide is added to the paint sludge, it might be necessary to provide heat abatement equipment to remove any excess heat that is generated by the exothermic reaction that occurs in the mixture. Removal or excess heat can be necessary to avoid the generation of Volatile Organic Compounds (VOC) from the paint sludge. For example thermal sludge dryers or mixers that produce inside chamber temperatures of more than 212° F. are known to generate VOC's from paint solids and therefore require additional emissions equipment.

Aside from process equipment selection and design, the amount of calcium oxide added can be determined based upon several variables, including the desired caloric value of the final fuel component, the amount of de-sulfuring required for a specific source of carbonaceous material source and any trade-off between caloric value and dc-sulfuring activity.

Lower percent solids by weight of paint sludge will require more calcium oxide to drive the extra water out to improve the caloric value. Dewatering or drying the paint sludge prior to the addition of calcium oxide can boost the percent solids. Increasing the solids percent by dewatering or drying can reduce processing equipment costs, since equipment such as decanters are less expensive and less expensive to operate than heat abatement equipment and emission treating equipment.

After the material is blended in the mixer 5 it can be conveyed out of this system by means of screw, belt or pneumatic conveyor as a final product identified in FIG. 1 by reference numeral 7.

The final product, referred to herein as a fuel component, can be collected in a discharge hopper and prepared for shipment.

FIG. 2 is a process flow diagram of a process for drying paint sludge according to another embodiment of the present invention which includes thermal treatment. The process depicted in FIG. 2 is similar to that shown in FIG. 1. The thermal treatment in the process of FIG. 2 (and FIG. 3) occurs in the mixer 5 as the exothermic reaction between the calcium oxide and paint sludge generates heat. The thermal treatment can be used to control the curing of the paint sludge and for example produce a semi-cured or fully cured paint sludge product. Further the thermal treatment can involve evaporative heating as discussed above. In FIGS. 2 and 3 the thermal treatment is illustrated by the greater amount of calcium oxide (40%-70%) that is added into the mixer 5 as opposed to the amount of calcium oxide (10%-30%) that is added into the mixer in FIG. 1.

In the process shown in FIG. 1 the solids content of the paint sludge that is fed into mixer 5 ranges from about 35-60 percent by weight and the amounts of calcium oxide and dewatered paint sludge added to the mixture range from about 10-30 percent by weight for the calcium oxide and from about 70-90 percent by weight for paint sludge. In the process shown in FIG. 2 the solids content of the paint sludge that is fed into mixer 5 ranges from about 35-60 percent by weight and the amounts of calcium oxide and dewatered paint sludge added to the mixture range from about 40-70 percent by weight for the calcium oxide and from about 30-60 percent by weight for paint sludge.

The end product can also be conveyed into a separator 8 (See FIG. 3), of conventional design, to segregate the de-sulfuring material (calcium oxide), from the paint solids (recoverable fuel), to produce two separate materials/products if desired. FIG. 3 is a process flow diagram of a process for drying paint sludge according to another embodiment of the present invention which includes thermal treatment and separation of constituents.

According to a further embodiment of the present invention, the dewatered paint sludge can be treated with a minimal portion of calcium oxide followed by evaporative heating to achieve a desired solids percentage content. This evaporative heating can be conducted in the mixer 5 using heat that is generated by the exothermic reaction between calcium oxide and paint sludge as discussed above. By adding a lower percentage of calcium oxide to the paint sludge a thermal reaction occurs but at significant lower temperatures less than 200° F., which can avoid the formation of VOC's and additional equipment for emission control.

The processes depicted in FIGS. 1-3 can be conducted as batch, semi-batch or continuous processes.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A process of producing a combustible fuel from paint sludge which comprises the steps of:
a) obtaining raw paint sludge from a painting facility;
b) subjecting the raw paint sludge to a dewatering process to obtain a dewatered paint sludge;
c) adding calcium oxide to the dewatered paint sludge to obtain a combustion fuel component; and
d) mixing the combustion fuel component from step c) with carbonaceous material to produce a combustible fuel.

2. A process of producing a combustible fuel from paint sludge according to claim 1, wherein the combustible fuel produced in step c) is further heated to evaporate additional water from the mixture.

3. A process of producing a combustible fuel from paint sludge according to claim 1, wherein step b) comprises at least one of filtration, filter pressing, centrifugation, decantation, distillation, extraction, freeze drying and fluidized bed drying.

4. A process of producing a combustible fuel from paint sludge according to claim 3, wherein step b) comprises decantation.

5. A process of producing a combustible fuel from paint sludge according to claim 1, wherein the temperature is controlled in step c) be to avoid the generation of volatile organic compounds.

6. A process of producing a combustible fuel from paint sludge according to claim 1, wherein step b) comprises at least two successive dewatering steps.

7. A process of producing a combustible fuel from paint sludge according to claim 2, wherein the solids content of the solids of the dewatered paint sludge is about 30-65 wt. %.

8. A process of producing a combustible fuel from paint sludge according to claim 1, wherein the carbonaceous material comprises coal.

9. A process of producing a combustible fuel from paint sludge according to claim 1, wherein in step c) about 10 to about 80 weight percent calcium oxide is added to about 20 to about 90 weight percent dewatered paint sludge.

10. A combustible fuel produced by:
a) obtaining raw paint sludge from a painting facility;
b) subjecting the raw paint sludge to a dewatering process to obtain a dewatered paint sludge;
c) adding calcium oxide to the dewatered paint sludge to obtain a combustion fuel component; and
d) mixing the combustion fuel component from step c) with carbonaceous material to produce a combustible fuel.

11. A combustible fuel according to claim 10, wherein the combustible fuel produced in step c) is further heated to evaporate additional water from the mixture.

12. A combustible fuel according to claim 10, wherein step b) comprises at least one of filtration, filter pressing, centrifugation, decantation, distillation, extraction, freeze drying and fluidized bed drying.

13. A combustible fuel according to claim 12, wherein step b) comprises decantation.

14. A combustible fuel according to claim 10, wherein the temperature is controlled in step c) be to avoid the generation of volatile organic compounds.

15. A combustible fuel according to claim 10, wherein step b) comprises at least two successive dewatering steps.

16. A combustible fuel according to claim 11, wherein the solids content of the solids of the dewatered paint sludge is about 30-65 to 100 wt. %.

17. A combustible fuel according to claim 10, wherein the carbonaceous material comprises coal.

18. A method of processing paint sludge which comprises:
a) obtaining raw paint sludge from a painting facility;
b) subjecting the raw paint sludge to a dewatering process to obtain a dewatered paint sludge;
c) adding calcium oxide to the dewatered paint sludge to obtain a combustion fuel component; and
d) mixing the combustion fuel component from step c) with carbonaceous material to produce a combustible fuel; and
d) combusting the combustible fuel.

19. A method of processing paint sludge according to claim 18, wherein the combustible fuel produced in step c) is further heated to evaporate additional water from the mixture.

20. A method of processing paint sludge according to claim 18, wherein step d) is performed in one of a furnace or boiler.
